(19) United States
(12) Patent Application Publication
(10) Pub. No.: US 2026/0347094 A1
(43) Pub. Date: Nov. 5, 2026

(54) CONTAINER AND SYSTEM FOR CONNECTING CONTAINERS

(71) Applicant: Busch Systems International Inc., Barrie (CA)

(72) Inventor: Craig Busch, Barrie (CA)

(73) Assignee: Busch Systems International Inc., Barrie, ON (CA)

(21) Appl. No.: 19/478,083

(22) PCT Filed: Apr. 26, 2024
(86) PCT No.: PCT/CA2024/050566

§ 371 Date: Oct. 23, 2025

Related U.S. Application Data
(60) Provisional application No. 63/498,995, filed on Apr. 28, 2023.

(51) Int. Cl. B65F 1/00; B65F 1/08; B65F 1/14; B65F 1/16

(52) U.S. Cl. CPC B65F 1/0053; B65F 1/08; B65F 1/1607; B65F 2001/0086; B65F 1/1473; B65F 1/1484; B65F 2220/101; B65F 2220/108

(57) ABSTRACT

The present disclosure discloses a container for collecting waste and/or recycling, the container comprising: a base; four corner elements; a top; and four side panels, wherein each corner element is attached to the base and the top to form a frame of the container and wherein each side panel is removably received by two of the four corner elements. A system for connecting containers is also disclosed.

### FIELD

The present disclosure relates to containers for receiving waste and/or recycling and to a system for connecting such containers.

### BACKGROUND

Containers or bins for receiving waste and/or recycling may be located in various locations for users to dispose their waste. Often, multiple containers are positioned adjacent each other to collect different types of waste and/or recycling. For example, three containers may be positioned adjacent each other for collecting a) waste intended for the landfill, b) compost and paper, and c) plastics to be recycled, respectively. Colour coding may be used to indicate which type of waste and/or recycling is intended for each container.

However, to date, colour coding and other means, such as small signage placed above the container or a label on the container lid, for instructing users on the type of waste and/or recycling to be deposited in the container has not always ensured proper separation by users. As such, there is a desire for improved ways to indicate to users what a particular container is intended to collect.

Moreover, it may be desirable to connect individual containers to each other to form a “station” or system for collecting multiple types of waste and/or recycling.

### SUMMARY

In some embodiments, there is provided a container for collecting waste and/or recycling, the container comprising: a base; four corner elements; a top; and four side panels, wherein each corner element is attached to the base and the top to form a frame of the container and wherein each side panel is removably received by two of the four corner elements.

In some embodiments, there is provided a system of containers comprising: first and second containers placed adjacent to each other, each container comprising a corner element forming part of a structural frame of the respective container; a connecting element for connecting a corner element of the first container with a corner element of the second container, the connecting element spanning a gap between the first and second containers.

### BRIEF DESCRIPTION OF THE DRAWINGS

Embodiments will be described, by way of example only, with reference to the accompanying figures wherein:

FIG. 1 is a perspective view a system of containers according to embodiments of the present disclosure.

FIG. 2 is a perspective view of the system of FIG. 1 without lids.

FIG. 3 is a perspective view of a container of the system of FIG. 1.

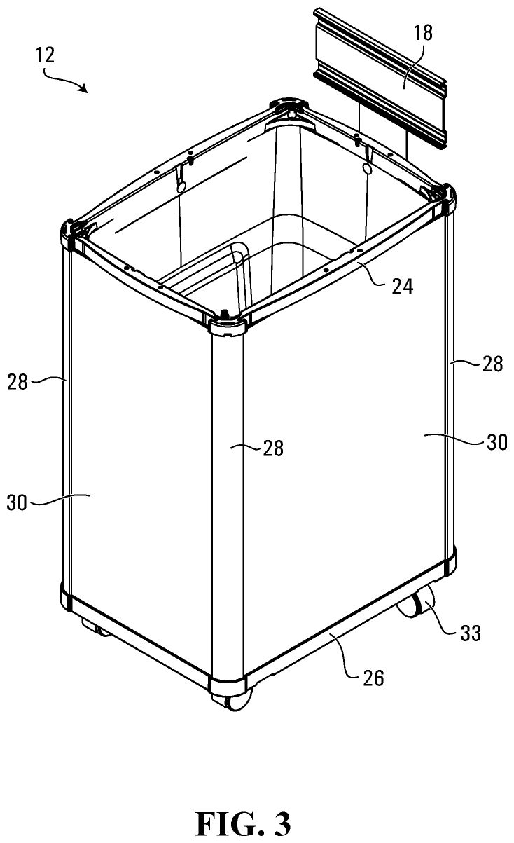

FIG. 4 is a perspective view of a base of the container of FIG. 3.

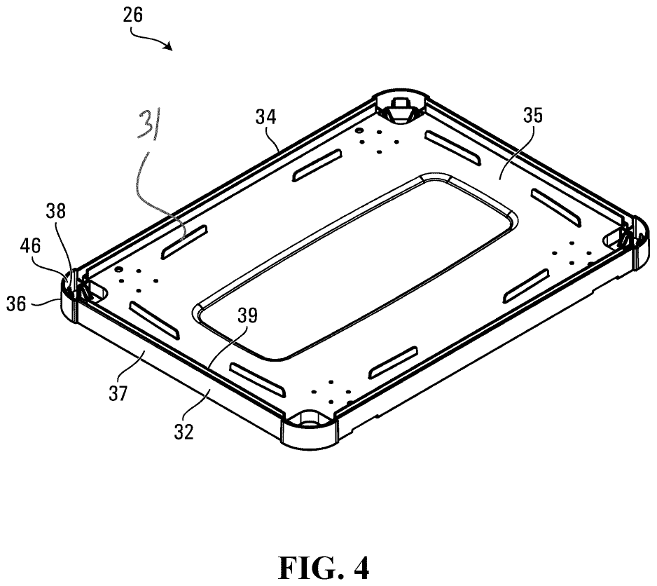

FIG. 5 is a perspective view of a top of the container of FIG. 3.

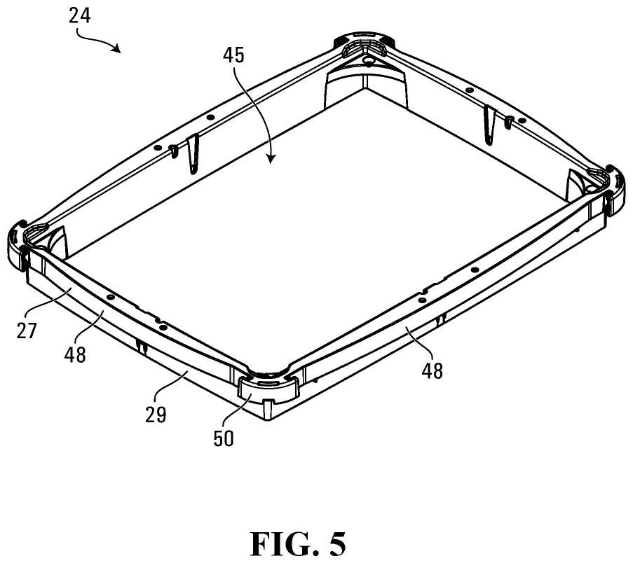

FIG. 6 is a front view of the container of FIG. 3.

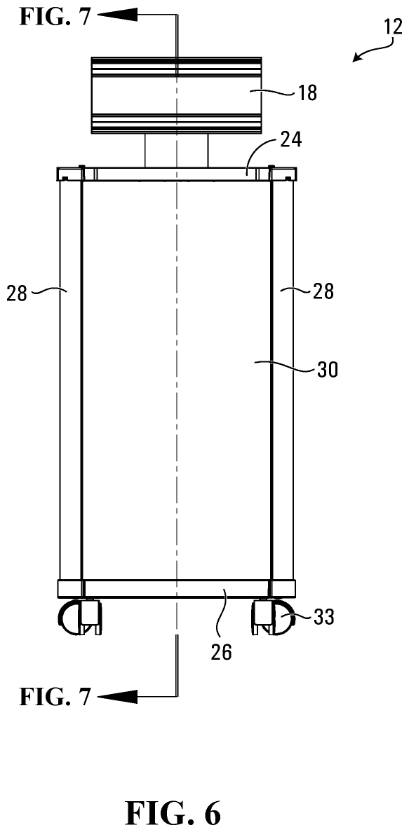

FIG. 7 is a right side view of the container of FIG. 3.

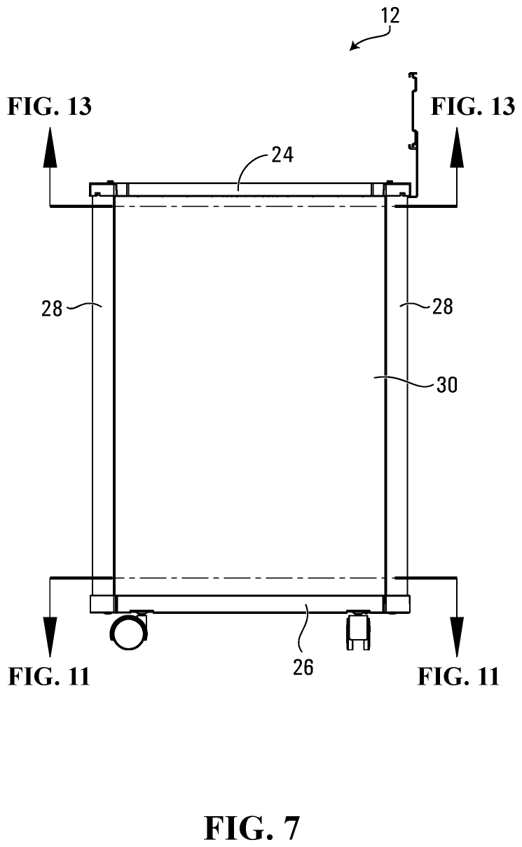

FIG. 8 is a cross-sectional view taken along line 7-7 in FIG. 6.

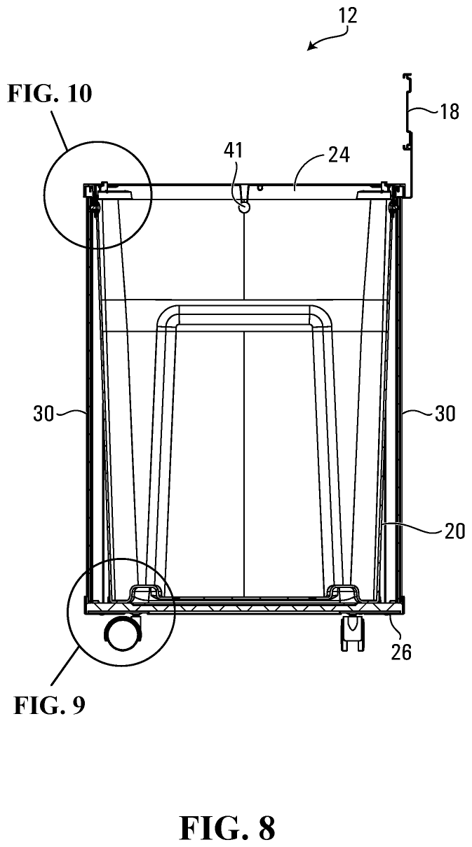

FIG. 9 is an enlarged view of the portion identified in FIG. 8.

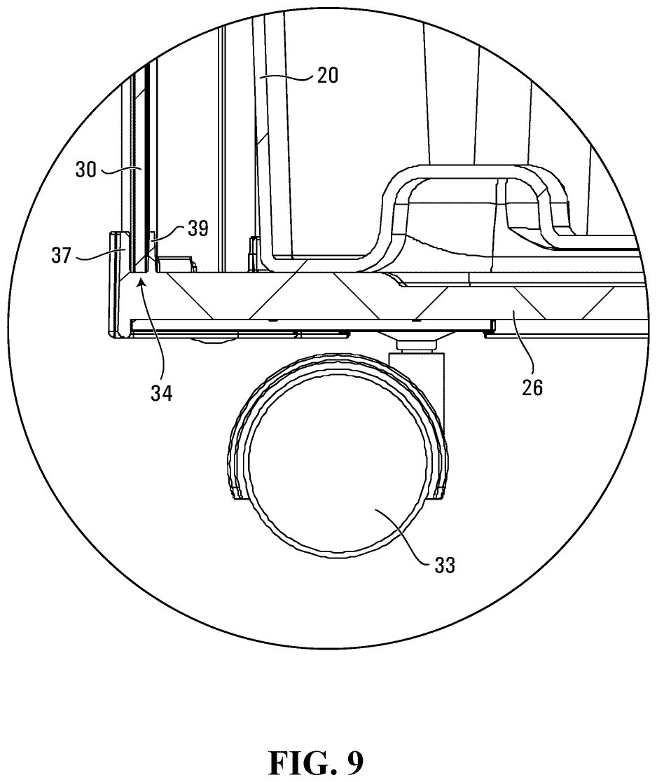

FIG. 10 is an enlarged view of the portion identified in FIG. 8.

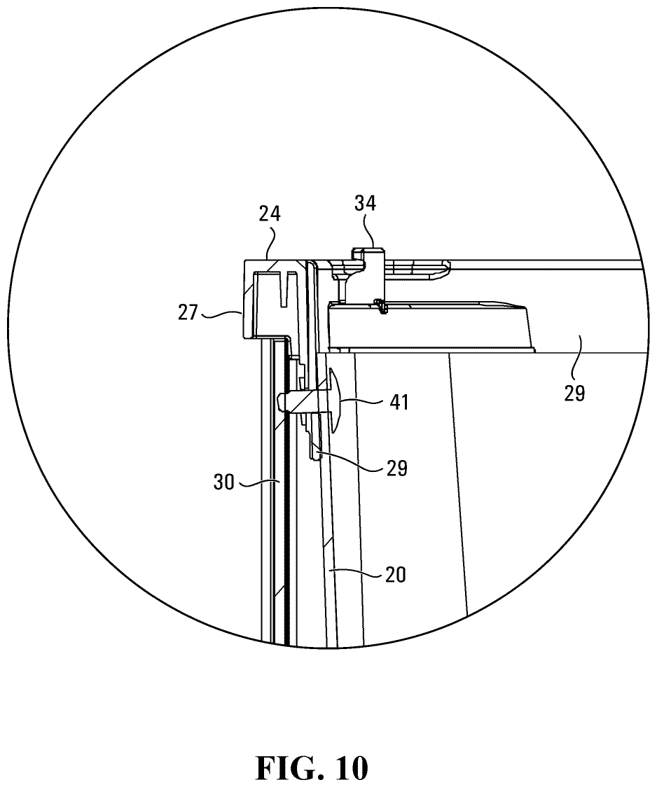

FIG. 11 is a cross-sectional view taken along line 11-11 in FIG. 7.

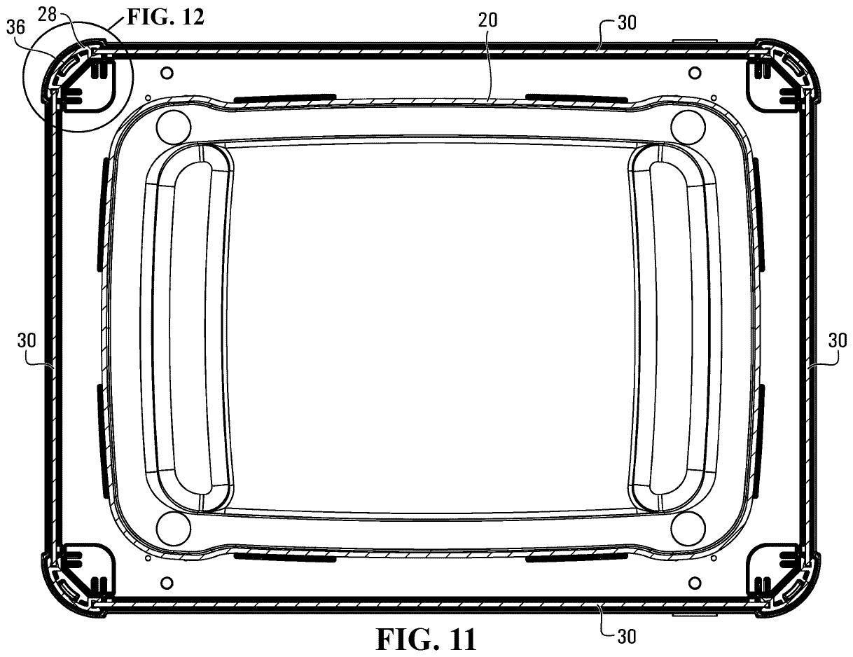

FIG. 12 is an enlarged view of the portion identified in FIG. 11.

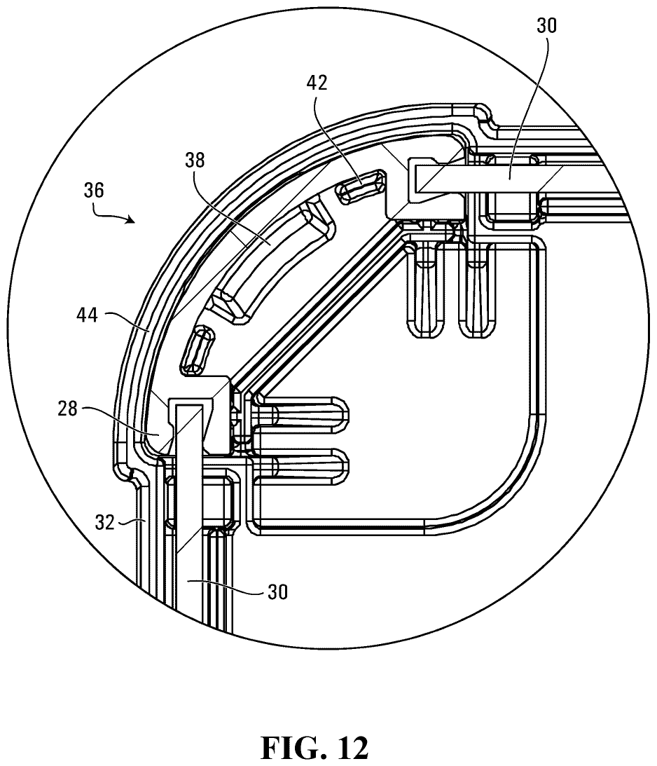

FIG. 13 is a cross-sectional view taken along line 13-13 in FIG. 7.

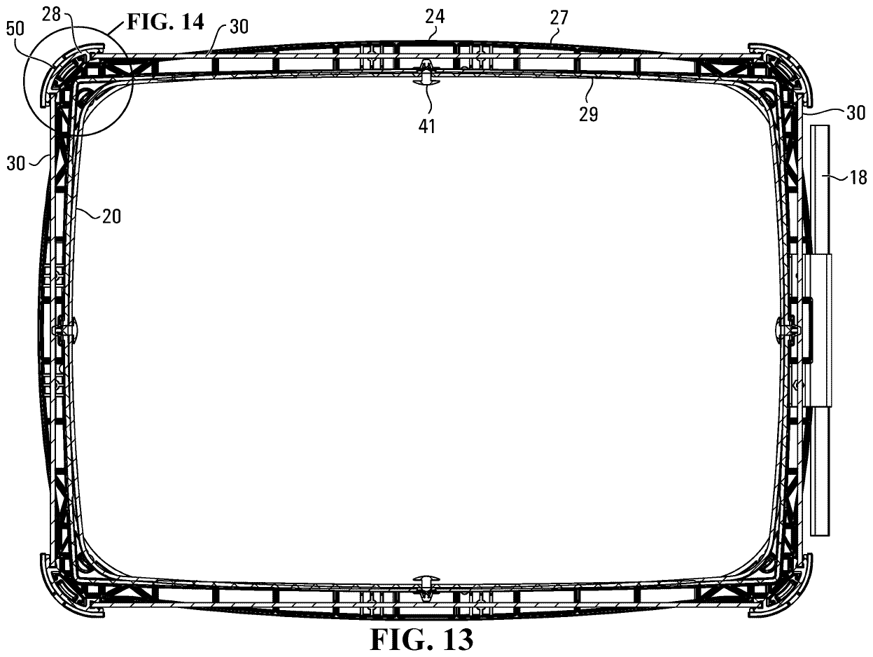

FIG. 14 is an enlarged view of the portion identified in FIG. 13.

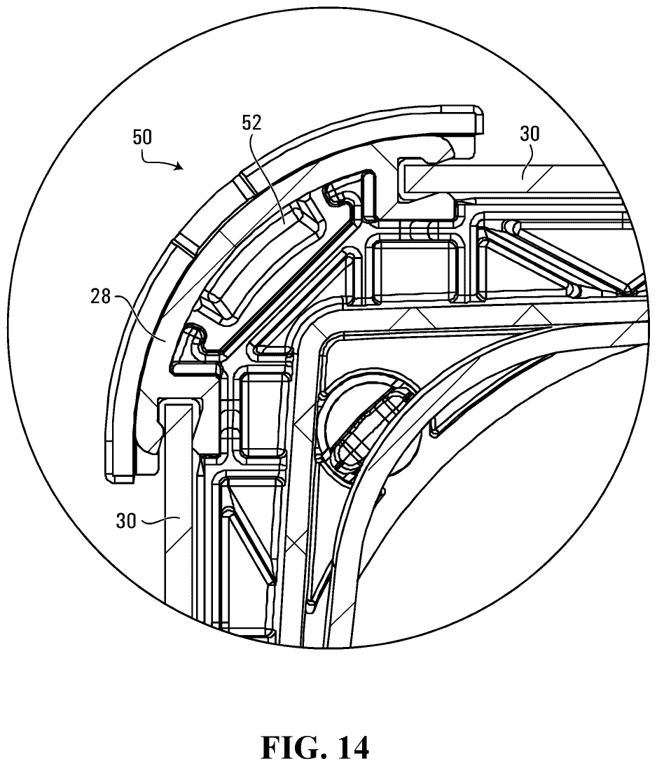

FIG. 15 is a perspective view of a corner element of the container of FIG. 3.

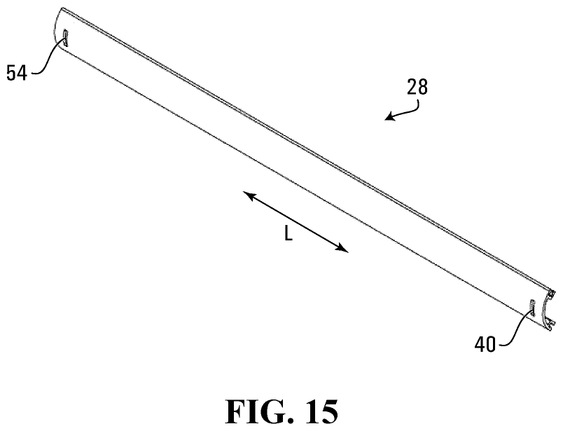

FIG. 16 is a planar view of a profile of the corner element of FIG. 15.

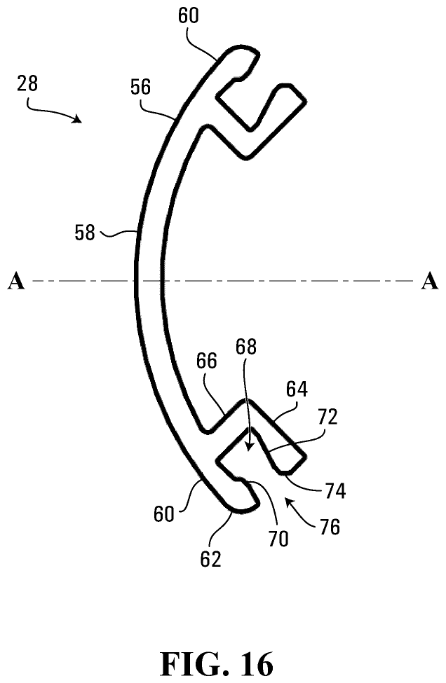

FIG. 17 is a front view of the system of FIG. 1.

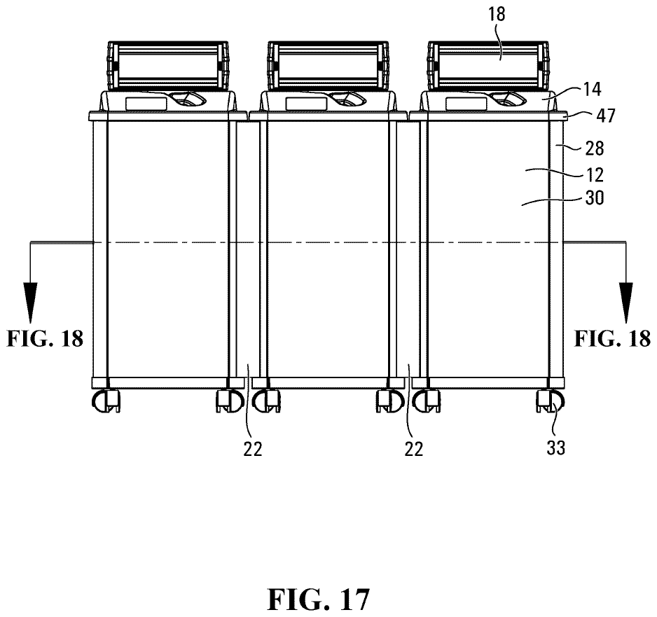

FIG. 18 is a cross-sectional view taken along line 18-18 in FIG. 17.

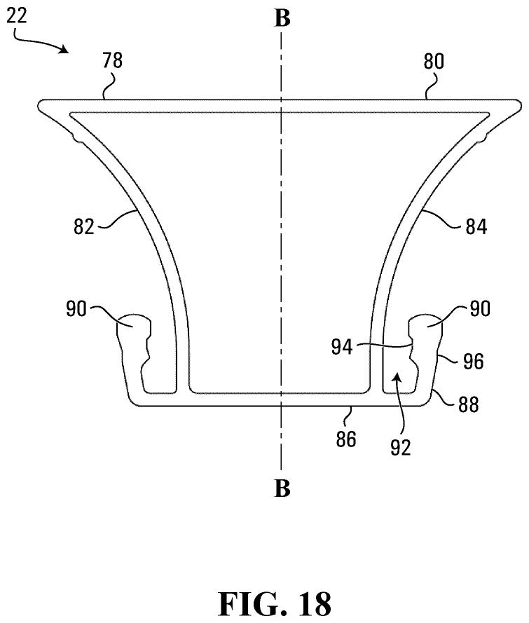

FIG. 19 is a profile of a connecting element of the system of FIG. 1.

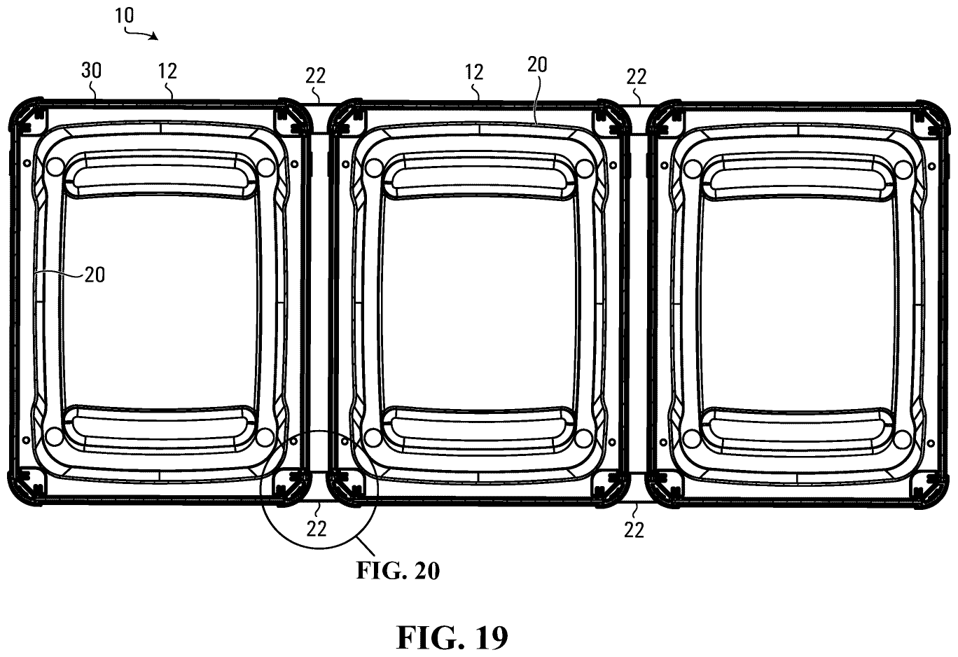

FIG. 20 is an enlarged view of the portion identified in FIG. 19.

### DETAILED DESCRIPTION

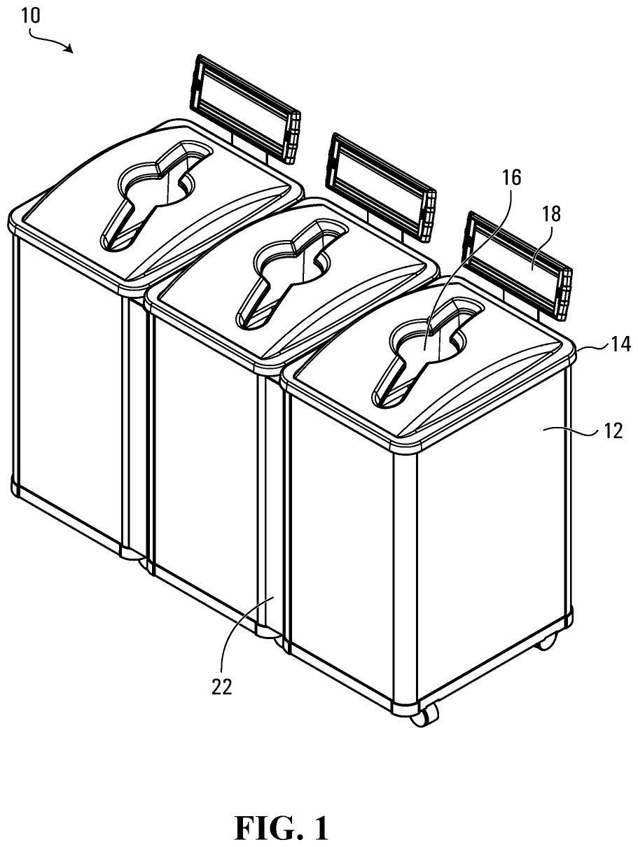

FIG. 1 shows a station or system 10 according to embodiments of the present disclosure. In the embodiment shown, the system 10 includes three containers 12 arranged adjacent to each other in a side-by-side configuration. While three containers are shown, a system 10 may include as few as two containers placed adjacent to each or more than three containers. Furthermore, the containers 12 of system 10 may be arranged end-to-end instead of side-by-side or a combination of side-by-side and end-to-end, as discussed further below.

The containers 12 are shown with lids 14. Each lid 14 includes an opening 16 for receiving waste and/or recyclable material. While one shape of opening 16 is shown, other shapes are possible and within the scope of the present disclosure. Each container 12 also includes a sign 18. The sign 18 may be used to indicate to a user what the respective container 12 is intended to collect. However, the sign 18 may be omitted and is not necessarily part of the system 10 or a container 12.

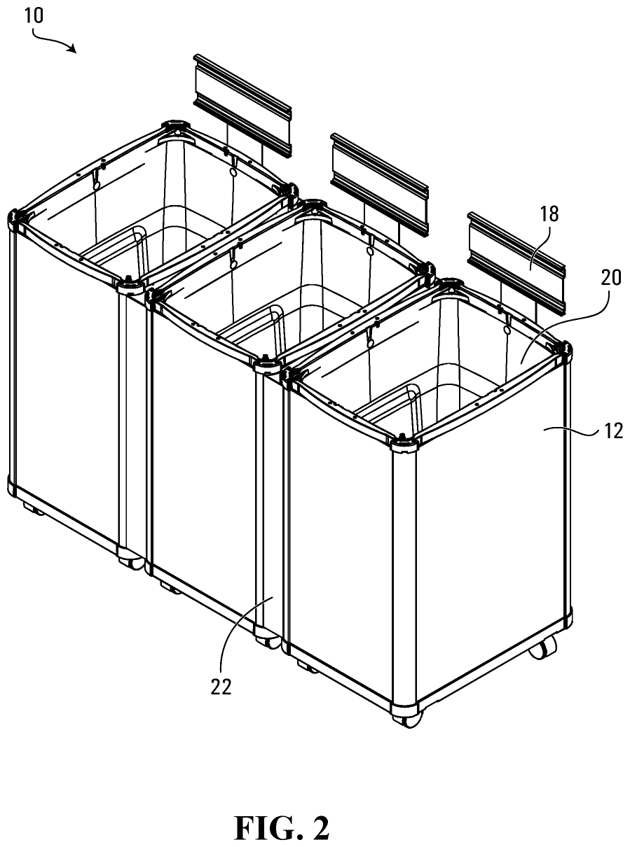

FIG. 2 shows the system 10 of FIG. 1 but without lids. Each container 12 includes an at least partially rigid liner 20 placed therein. A bag (not shown) may be inserted into the liner 20 for collection of waste and/or recyclables.

Adjacent containers 12 in the system 10 may be connected to each other using a connecting element 22. The connecting element 22 spans the space between adjacent containers 12 and may aid in preventing adjacent containers from separating. The connecting element 22 may also aid in providing a front of the system 10 with a uniform or more consistent appearance, such that the system 10 appears as a unitary structure or single entity rather than separate containers merely placed adjacent to each other. The connecting element 22 will be described in greater detail below.

A container 12 according to embodiments of the present disclosure, includes a top 24, a bottom or base 26, four corner elements 28 and four side panels 30. The corner elements 28, top 24 and base 26 form a frame of the container 12. Each corner element 28 is attached to the top 24 and base 26. Each side panel 30 is removably received in the base 26 and two of the four corner elements 28. In some embodiments, the side panel 30 is only removably received in two of the four corner elements. In other embodiments, the side panel 30 is received in one or more of the base, the top, and one or more corner elements.

In the illustrated embodiment, two of the four side panels 30, which are located at the front and rear of the container 12, are narrower than the two side panels 30 located at the opposing sides of the container 12. This results in the container generally have a shape of a rectangular prism. Other relative sizes and shapes of side panels 30 are possible. All side panels 30 may have the same dimensions. The side panels may be rectangular or square, for example. In the illustrated embodiment, the side panels 30 have uniform and common thickness. In other embodiments, not all side panels have uniform and/or common thickness.

The base 26 may have a generally square or rectangular shape having four sides 32, each corresponding to one of the side panels 30. The base 26 provides a structural element and bottom to the container 12. Casters 33 or other footing may optionally be included on and attached to an underside of the base 26. Thus, while four casters 33 are shown, the casters may be omitted.

In the illustrated embodiment, the base provides a substantially continuous floor 35 for the container 12. However, other configurations are possible and included within the present disclosure. For example, the base may be discontinuous and include one or more apertures between a top and bottom surface. Moreover, structural features, such as ribs, may be included to improve the structural strength of the base 26. The base 26 may be manufactured of various suitable materials, such as plastics, metals or combination of plastics and metals.

One or more upwardly projecting protrusions 31 may be included to aid in positioning and/or supporting the liner 20, which tapers towards and contacts the base 26.

A channel 34 may extend along or adjacent at least a portion of each side 32 of the base 26. In the illustrated embodiment, the channel 34 is defined between a side wall 37 and a channel wall 39 protruding from an upper surface of the base 26. In the illustrated embodiment, the channel 34 removably receives a bottom of a respective side panel 30. In other embodiments, the channel 34 may be omitted and the side panel 30 would merely rest on the base 26.

The channel 34 may have a width sized to removably receive a thickness of the respective side panel 30 with sufficient clearance to permit the side panel 30 to be removably received, for example, by sliding the side panel 30 in and out of the channel 34. However, the width of the channel 34 may be sufficiently close to the thickness of the side panel 30 to substantially prevent the side panel 30 from tilting or moving laterally, thereby assisting in maintaining the side panel 30 in an upright position. In addition, or instead, the channel 34 may also be provided with a sufficient depth to aid in maintaining the side panel 30 in an upright position.

The base 26 also includes four corner portions 36. Each corner portion receives and engages with a respective corner element 28. In particular, in the illustrated embodiment, a resilient tab 38 located on an interior of the corner portion 36 and extending upwards from the upper surface of the top 26 includes a protruding portion that engages with a corresponding base aperture 40 in the corner element 28. Thus, according to the present disclosure, the corner element 28 may be snapped into engagement with a respective corner portion 36 and thus base 26. Other configurations for snapping the corner element 28 to the base are possible and within the scope of the present disclosure. In other embodiments, the corner elements may be affixed to the base in another manner, such as with screws.

Moreover, protrusions 42 protruding from the base 26 cooperate with a raised wall 44 on an exterior edge of the corner portion 36 to form a receiving gap 46 that is also shaped complementary to a shape of the profile of the corner element 28. The receiving gap 46 receives an end of the corner element 28. Other configurations for receiving and engaging the corner elements and the base are possible and within the scope of the present disclosure.

The top 24 may have a generally square or rectangular shape having four sides 48, each corresponding to one of the side panels 30. The top 24 provides a structural element and top to the container 12. Because the top 24 includes a sufficiently large opening 45, additional structural features, such as ribbing, may be provided between outer and inner wall portions 27, 29 of the top 24 to increase the structural rigidity of the top 24.

The inner wall 29 of the top 24 also optionally includes apertures through which pins or clips 41 may be inserted for attaching the liner 20 thereto. In the illustrated embodiment, the apertures for connecting the liner 20 are provided in a portion of the inner wall 29 that extends further down than the outer wall 27. The top 24 may also include open slots above the apertures to permit a tool to be inserted to disconnect the top 24 from the liner 20 by disengaging clips 41.

Other configurations for attaching the liner to the top 24 are also possible and within the scope of the present disclosure. Moreover, in some embodiments, the liner may not be attached to the top at all. In other embodiments the top and liner may be connected prior to assembly of the container or may be a unitary piece.

The top 24 may include bag retention features 43 to aid a user in retaining a bag within the liner 20. In the illustrated embodiment, there are four bag retention features 43, each one located at an interior corner of the top 24. The bag retention features 43 may be separate pieces inserted into and connected with the top 24. In other embodiments the bag retention features 43 may be integral with the top 24. In other embodiments the bag retention features may be omitted entirely.

In the illustrated embodiment, the outer wall 27 is bowed or curved, such that a thickness of the side 48 between the outer wall 27 and inner wall 29 is thickest at a midpoint of the side 48 and then narrows again towards opposing ends. This bowing may aid in improving structural rigidity of the top 24, for example by allowing additional spacing for ribs or other structural features between the outer and inner walls 27, 29. It may also aid in providing a portion of the top 24 that extends above an upper edge of a respective side panel 30, when installed, to aid in maintaining the side panel 30 in place.

The lid 14 is shaped complementary to the top 24 so that when the lid 14 is placed on the top 24, the top 24 is concealed. In particular, the lid 14 includes a downwardly protruding rim 47 sized to have an internal heigh matching or exceeding that of the height of the top 24—in particular the outer wall 27—and with a complementary shape to an exterior perimeter of the top 24.

In the illustrated embodiment, each side 48 is positioned above a respective side panel 30. In other embodiments, the top may include channels or other elements configured to receive and engage with the side panels.

The top 24 also includes corner portions 50. Each corner portion 50 receives and engages with a respective corner element 28. In particular, in the illustrated embodiment, a resilient tab 52 located on an interior of the corner portion 50 and extending downward engages with a corresponding top aperture 54 in the corner element 28, with the corner portion 50 resting on a top edge of the corner element. Thus, the corner element 28 may be snapped into engagement with a respective corner portion 50. Other configurations for snapping the corner element to the top 24 are possible and within the scope of the present disclosure. In some embodiments, the corner element may be affixed to the top in another manner, for example with screws.

A shape of the corner portion 50 is also shaped complementary to a shape of the profile of the corner element 28, in order to receive and/or mate therewith. Interior ribbing and/or protrusions extending downwardly on an underside of the corner portion 50 may form a shape complementary to the profile of the corner element 28. Other configurations for receiving and engaging the corner elements and the top are possible and within the scope of the present disclosure.

Each corner element 28 is configured as an elongated body or extrusion with a profile 56. The profile 56 includes a curved bracket portion 58 connecting opposing and identical end clips 60. The corner element 28 is symmetrical about an axis A bisecting the curved bracket portion 58 as well as about a mid-line of a length direction L.

Each end clip 60 includes an exterior portion 62, an interior portion 64 and a cross-portion 66 that together form a cross-sectional profile of a channel 68. The exterior portion 62 has an end formed with a nub or protrusion 70 on an interior side thereof running along at least part of the exterior portion 62 in the length direction L.

The interior portion 64 includes a tapering portion 72 ending in a curved bead 74 running along at least part of the interior portion 64 in the length direction L. The tapering portion 72 is configured to result in a narrowing of the channel 68 with a width of an opening 76 of the channel 68 being narrower than a width of the channel 68 at the cross-portion 66.

The channel 68 is sized to removably receive a side panel 30. In particular, a side panel 30 may be slid into the channel 68, with the protrusion 70 and curved bead 74 contacting opposite sides of the side panel 30. The exterior and/or interior portions 62 and 64 may have some resiliency so that, in an unflexed position, the width of the opening 76 is smaller than a thickness of the side panel 30, with the exterior and/or interior portions 62 and 64 flexing to accommodate the thickness of the side panel 30. This may aid in retaining the side panel 30 in the channel 68.

Other embodiments of the corner element are possible. The shape and configuration of both the cross-portion and clips may be varied. One or more features of the corner elements may be modified or omitted while still permitting removable receipt of the side panel. In particular, other configurations that permit the side panel to be slid in and out of the corner element are possible and within the scope of the present disclosure. For example, in some embodiments the corner element includes a channel that differs in configuration from the channel shown in the illustrated embodiment, for example by omitting the nub and bead and/or by having a constant width.

The connecting element 22 is configured as an elongated body or extrusion with a profile 78 that is symmetrical about an axis B bisecting the profile. The profile 78 includes a flat front portion 80 that extends between ends of two curved side portions 82, 84. The curved side portions 82, 84 extend from the front portion 80 to a flat back portion 86. The back portion 86 is substantially parallel to the front portion 80 and extends on either end beyond the curved side portions 82 and 84. At each end of the back portion 86, the connecting element 22 includes identical lips 88 extending from the back portion 86 generally in a direction toward the front portion 80. Each lip 88 includes an interface portion 90. The lip 88 and interface portion 90 form a channel 92 with a respective opposing curved side portion 82 or 84 and the back portion 86.

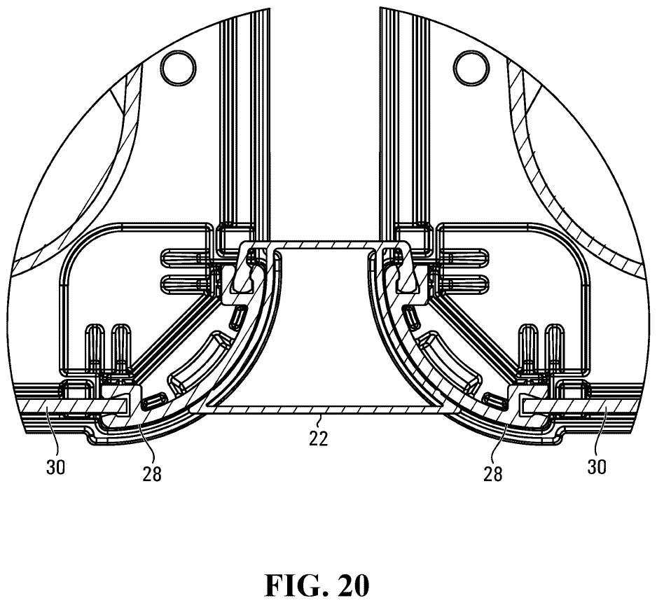

The interface portion 90 is sized and configured to be at least partially complementary to the channel 68 of the corner element 28. In particular, the interface portion 90 includes an indent or groove 94 facing an interior of the channel 92 sized to receive the protrusion 70 of the exterior portion 62 of the corner element 28, as seen for example in FIG. 20. The interface portion 90 also includes groove or indent 96 on a side of the interface portion 90 facing away from the channel 92 that is complementary with and configured to contact the bead 74 on the interior portion 64 of the corner element 28.

Moreover, the curved side portions 82, 84 have a curvature matching that of the curved bracket portion 58 of the corner element 28. Thus, the connecting element 22 is configured to receive and mate with two corner elements 28. In so doing, a portion of each curved bracket portion 58 contacts along a length of one of the curved side portions 82, 84 of the connecting element 22. Each channel 92 of the connecting element 22 receives a respective exterior portion 62 of the corner element 28, while each channel 68 of the corner element 28 receives an interface portion 90 of the connecting element 22.

Other embodiments of the connecting element are possible.

Two adjacent containers 12 may be connected together using connecting element 22. Namely, a user may remove the two side panels 30 facing each other when the containers 12 are placed next to each other. This frees up the end clips 60 that had received the side panels 30. The connecting element 22 may then be inserted and, for example, slid into the free clips 60 which are also adjacent each other in order to engage the connecting element 22 with the corner elements 28. The complementary curvatures of the side portions 82, 84 and the curved backet portion 58 of each corner element 28 may allow for a seamless and intentional appearance. From an exterior, the front portion 80 may appear to span a portion of the space between adjacent corner elements 28. Thus, a different configuration of the front portion 80 may provide a different appearance to the front of the connected containers. All such configurations are within the scope of the present disclosure.

Accordingly, each corner element 28 has two engagement portions, each being configured to selectively engage a side panel and a connecting element. For example, in the illustrated embodiment, the engagement portion of the corner element 28 includes end clip 60 that is configured to selectively engage a side panel 30 and the connecting element 22. The engagement portion may be configured differently in other embodiments according to the present disclosure.

The connection and disconnection of the adjacent containers 12 can be accomplished by removal of the respective lids 14 and tops 24. The side panels 30 may then be removed and the connecting elements 22 inserted, followed by replacement of the tops 24 and the lids 14. The modularity and configuration of the corner elements 28 and connecting elements 22 allow the containers 12 to be arranged and connected side-by-side or end-to-end. It will be appreciated that more than two containers 12 may be connected in this manner.

In some embodiments, the side panels form signage with text and/or images on an exterior thereof to further indicate to users information, such as the type of waste and/or recycling to be collected in the container. The configuration of the container and its elements described herein may also allow for a user to easily switch out or include signage as desired by removing the respective lid and top of a container, slide out a side panel and switch it with a different, desired panel. The side panels may have sufficient flexibility so that they can be flexed and sufficiently bowed to bypass the top as they are slid up and outward after removing the lid. For example, in the illustrated embodiment, the side panels may be flexed toto bypass the bowed outer wall of the top as described above.

Numerous specific details have been set forth in order to provide a more thorough understanding of the inventive concepts. However, it will be apparent to one of ordinary skill in the art that the inventive concepts within the instant disclosure may be practiced without these specific details. In other instances, well-known features have not been described in detail to avoid unnecessarily complicating the instant disclosure.

As used herein, the terms “comprises,” “comprising,” “includes,” “including,” “has,” “having” or any other variation thereof, are intended to cover a nonexclusive inclusion. For example, a composition, a process, method, article, or apparatus that comprises a list of elements is not necessarily limited to only those elements but may include other elements not expressly listed or inherently present therein.

As used herein the terms “approximately,” “about,” “substantially” and variations thereof are intended to include not only the exact value qualified by the term, but to also include some slight deviations therefrom, such as deviations caused by measuring error, manufacturing tolerances, wear and tear on components or structures, stress exerted on structures, and combinations thereof, for example.

Use of the “a” or “an” are employed to describe elements and components of the embodiments herein. This is done merely for convenience and to give a general sense of the inventive concepts. This description should be read to include one or at least one and the singular also includes the plural unless it is obvious that it is meant otherwise.

Any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment. Moreover, it will be understood that features of one embodiment may be combined with features of other embodiments, even if not expressly recited or described as a combination.

1. A container for collecting waste and/or recycling, the container comprising:
a base;
four corner elements;
a top; and
four side panels,
wherein each corner element is attached to the base and the top to form a frame of the container and wherein each side panel is removably received by two of the four corner elements.

2. The container of claim 1, where each side panel is removably received by the base.

3. The container of claim 1, wherein each corner element has two channels running at least partially along a length of the corner element and wherein each channel removably receives a respective side panel.

4. The container of claim 1, wherein each corner element has a cross-sectional profile having a curved portion with first and second ends, each end including a channel for removably receiving a respective side panel.

5. The container of claim 1, wherein each corner element is connectable to the top and base via a snap connection.

6. The container of claim 5, wherein each corner element includes an opening at respective first and second ends thereof, each opening receiving a respective resilient tab protruding from the top and the base.

7. The container of claim 1, further comprising a lid having a downward extending rim, the rim sized and configured to obscure sides of the top.

8. The container of claim 1, further comprising a rigid liner placed within the container and removably connected to the top.

9. The container of claim 1, wherein each side panel is capable of being slid in and out of its position.

10. The container of claim 1, wherein each panel is capable of being flexed to bypass the top and be removed.

11. A system of containers comprising:
first and second containers placed adjacent to each other, each container comprising a corner element forming part of a structural frame of the respective container;
a connecting element for connecting a corner element of the first container with a corner element of the second container, the connecting element spanning a gap between the first and second containers.

12. The system of claim 11, wherein each corner element includes a channel running at least partially along a length of the corner element and wherein the connecting element has first and second interface portions received within the channels of the corner elements being connected.

13. The system of claim 12, wherein one of the interface portion and the channel includes a protrusion that is received in a groove of the other of the interface portion and the channel.

14. The system of claim 12, wherein the connecting element includes two side portions, each side portion shaped complementary to at least a portion of an exterior of a respective corner element.

15. The system of claim 14, wherein the connecting element includes a front portion spanning between the two side portions.

16. The system of claim 12, wherein each of the first and second container include four corner elements and three side panels, each side panel being removably received by two corner elements, and wherein side panels are omitted on the sides of the first and second container facing each other when the first and second containers are connected.

17. The system of claim 11, wherein the connecting element is configured as an extrusion having a profile.

18. The system of claim 11, the system further comprising one or more side panels, wherein each corner element includes an engagement portion that is configured to selectively engage one of the side panels and the connecting element.
